(19) United States
(12) Patent Application Publication
(10) Pub. No.: US 2014/0166568 A1
(43) Pub. Date: Jun. 19, 2014

(54) BASKET

(71) Applicant: FLSmidth A/S, Valby (DK)

(72) Inventor: David Starr, Forest Lake (AU)

(73) Assignee: FLSmidth A/S, Valby (DK)

(21) Appl. No.: 14/133,727

(22) Filed: Dec. 19, 2013

(30) Foreign Application Priority Data
Dec. 19, 2012 (AU) 2012905627

(51) Int. Cl. B01D 33/044

(52) U.S. Cl. CPC B01D 33/044
USPC 210/360.1

(57) ABSTRACT

A basket for a horizontal centrifuge, the basket that has a frusto-conical body having a series of accelerator bars with each of the accelerator bars having a width greater than 20 mm.

### FIELD OF THE INVENTION

This invention relates to a basket. In particular the invention relates to a basket for use in a mineral processing centrifuge that has improved wear properties.

### BACKGROUND OF THE INVENTION

Horizontal centrifuges have been used in mineral processing for sometime. Centrifuges are primarily used to dewater coal and mineral material. That is, to remove liquids from the solids materials. A key element of a centrifuge is a wire basket which is rotated in order to dry the coal or minerals. In use, coal or mineral slurry is fed into a feed end of the basket whilst the basket is rapidly spinning to cause the material slurry to be forced against an inner periphery of the basket. The centrifugal force imparted to the slurry causes water to be forced from the coal or minerals through slots located within the basket.

An important factor in the operation of any horizontal centrifuge is to ensure that when the slurry is feed into the basket, the slurry is accelerated to match the rotational speed of the basket as quickly as possible. Most basket wear is caused when the slurry that is being processed moves tangentially (i.e. the slurry rotates) around the basket instead of moving axially. When a basket wears prematurely, the basket must be replaced. This is costly due to cost of the basket and the substantial downtime cost.

An effective way in which to quickly accelerate the coal or mineral slurry when it is feed into the basket is to place a number of vanes (know in the art as “accelerator bars”) within the basket adjacent the feed end of the basket. The accelerator bars extend axially with respect to the basket. As such, when material is feed into the basket, the accelerator bars assist in preventing the slurry from moving tangentially around the basket and hence reduce basket wear.

Unfortunately, when the slurry is feed into the basket, the slurry can run over the top of the accelerators causing the accelerator bars to wear. This reduces the effectiveness of the accelerator bars. The more the accelerators bars wear, the less effective the accelerator bars become at preventing tangential movement of the mineral slurry and hence the accelerator bars become less effective in reducing basket wear.

The reference to any prior art in this specification is not, and should not be taken as, an acknowledgement or any form of suggestion that the prior art forms part of the common general knowledge.

### OBJECT OF THE INVENTION

It is an object of the invention to overcome and/or alleviate one or more of the above disadvantages or to provide the consumer with a useful or commercial choice.

### SUMMARY OF THE INVENTION

In one form, although not necessarily the only or broadest form, the invention resides in a basket for use in a centrifuge, the basket having a series of accelerator bars that are resistant to tangential wear from a mineral slurry.

In another form the invention resides in a basket for a horizontal centrifuge, the basket comprising:

a frusto-conical body having a series of accelerator bars;

wherein each accelerator bar has a width greater than 20 mm.

The body includes a feed end and a delivery end. The feed end is located adjacent a small diameter end of the body whilst the delivery end is located adjacent a large diameter end of the body.

Normally the fusto-conical body includes a screen member. The screen member may include a series of screen elements. The screen elements may be in the form spaced apart wire members. The screen member may include a frame. The frame may be formed from a series of axial stringer and circumferential ribs.

The series of accelerator bars may be located over the screen member. The series of accelerator bars may be located adjacent the feed end of the basket.

The body may also include a feed end flange. The body may also include a delivery end flange.

The accelerator bars may be in the form of a rectangular shaped prism. The height of the accelerator bars may be between 10 and 30 mm. Preferably, the height of the accelerator bars are between 15 and 25 mm. More preferably, the accelerator bars are approximately 20 mm height.

Preferably, the accelerator bars have a width greater than 30 mm. More preferably, the accelerator bars are have a width greater than 40 mm.

Preferable, the accelerator bars have a width between 20 mm and 70 mm. More preferably, the accelerator bars have a width between 35 mm and 55 mm.

### BRIEF DESCRIPTION OF THE DRAWINGS

Embodiment of the invention, by way of example only, will now be described with reference to the accompanying drawings in which:

FIG. 1 is a perspective view of a prior art basket;

FIG. 2 is a further perspective view of the basket of FIG. 1;

FIG. 3 is a perspective view of an improved basket according to an embodiment of the invention.

### DETAILED DESCRIPTION OF THE INVENTION

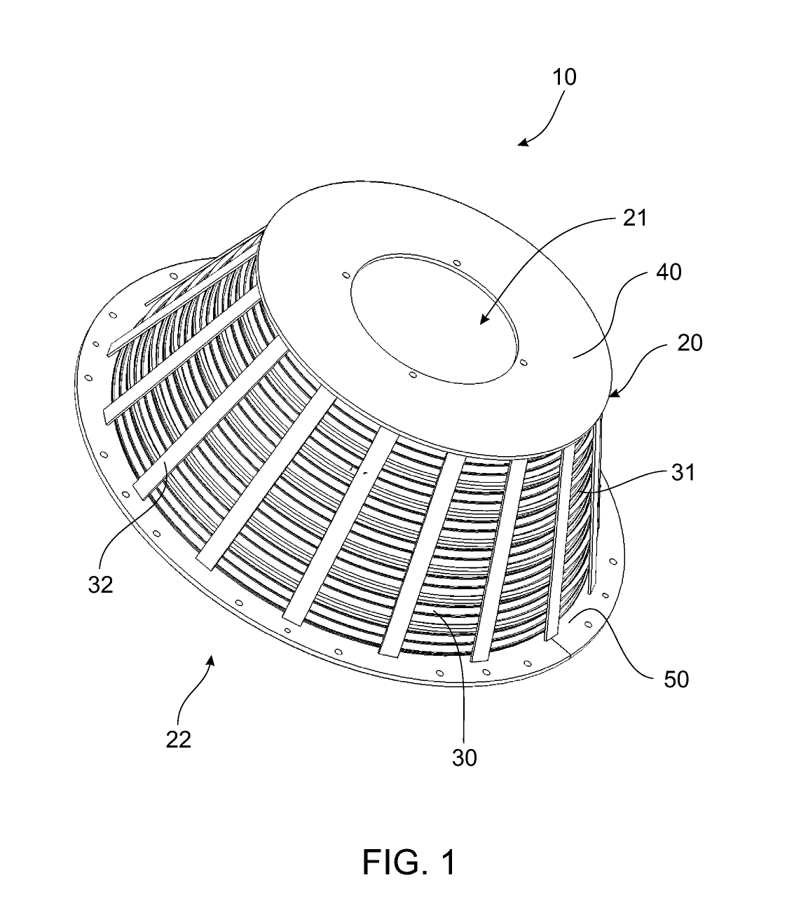

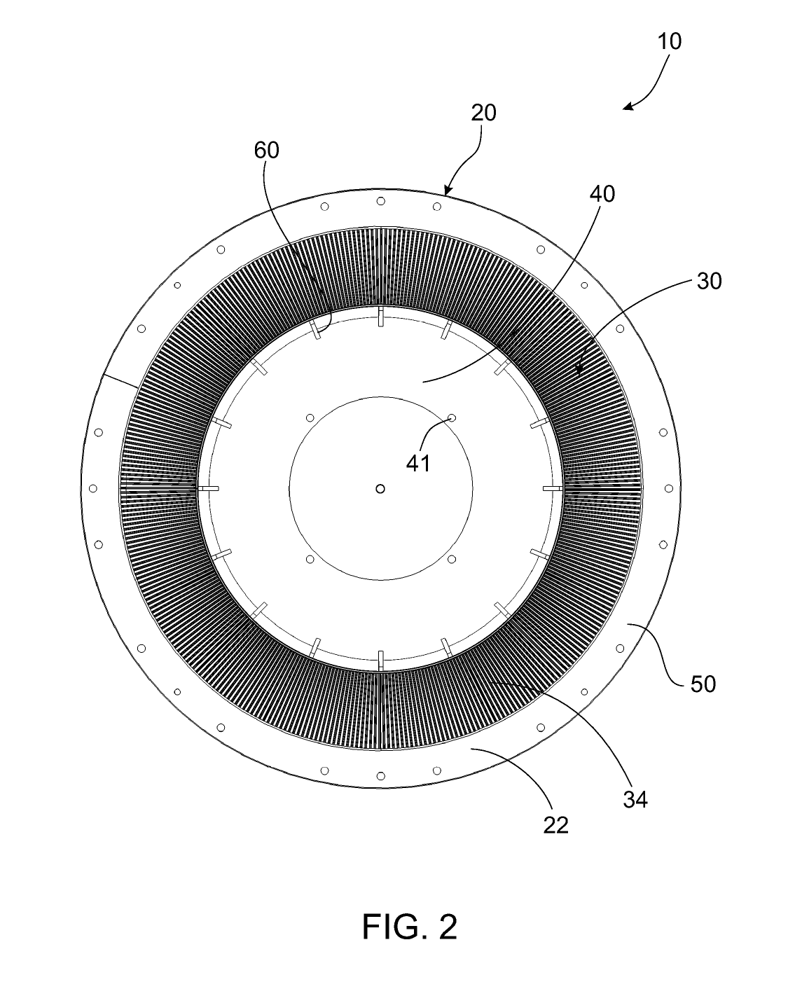

FIGS. 1 and 2 show a prior art a prior art basket 10 that is used within a horizontal centrifuge. In particular, the basket shown is used in the HFC 1300 centrifuge is current manufactured by FLsmidth Ludowici Pty Ltd.

The prior art basket is formed from a body in the shape of a truncated cone. Accordingly, the body 20 includes a feed end 21 (located adjacent a small diameter of the body) and a delivery end 22 (located adjacent a large diameter of the body). The body 20 includes a screen member 30, feed end flange 40 and delivery end flange 50.

The screen member 30 is located between the feed end flange 40 and the delivery end flange 50. The screen member 30 is from a series of spaced-apart circumferential ribs 31 and series of axial stringers 32. The stringers 32 are welded to the ribs 31. The stringers are placed radially outward from ribs 31. Screen elements 34 are attached to the ribs. The screen elements 34 are normally in the form of a plurality of wire members that are arranged side-by-side. The wire members are spaced slightly apart so as to form slots. Normally, the slots (not shown) are formed by the arranging the wire members so that the wire members extend substantially axially relative to the basket. Wire members are normally formed from steel or stainless steel wedge or profiled wires.

The feed end flange 40 is made from steel. The feed end flange 50 extends outwardly with respect to the screen member 30 and is welded to screen member 30. A series of holes 41 extend through the feed end flange 40. The holes 41 are circumferentially spaced around the flange 40.

The delivery end flange 50 is made from steel. The delivery end flange 50 extends outwardly with respect to the screen member 30 and is welded to screen member 30. A series of holes 41 extend through the delivery end flange 40 to connect the basket to a basket carrier (not shown) via bolts (not shown). The holes 51 are circumferentially spaced around the delivery flange.

A series of accelerator bars 60 are located adjacent the feed end of the basket 10. The accelerator bars 60 are located over the screen member 30. The accelerator bars 60 are rectangular in transverse cross-section which does not substantially vary through the length each accelerator bars 60. The accelerator bars 60 are 20 mm high, 10 mm wide and 100 mm in length. The accelerator bars 60 are equally circumferentially spaced around the screen member 30. The accelerator bars 60 are oriented substantially axially with respect to the body 20.

Flsmidth Ludowici Pty Ltd has spent considerable time and effort in attempting to reduce accelerator bar wear. These attempts included increasing the height of the accelerator bars and making the accelerator bars from different materials. Unfortunately, this these attempts were unable to provide a commercially viable solution to the problem of increasing accelerator bar life. After various attempts, FLsmidth Ludowici Pty Ltd found a surprising solution to accelerator bar wear.

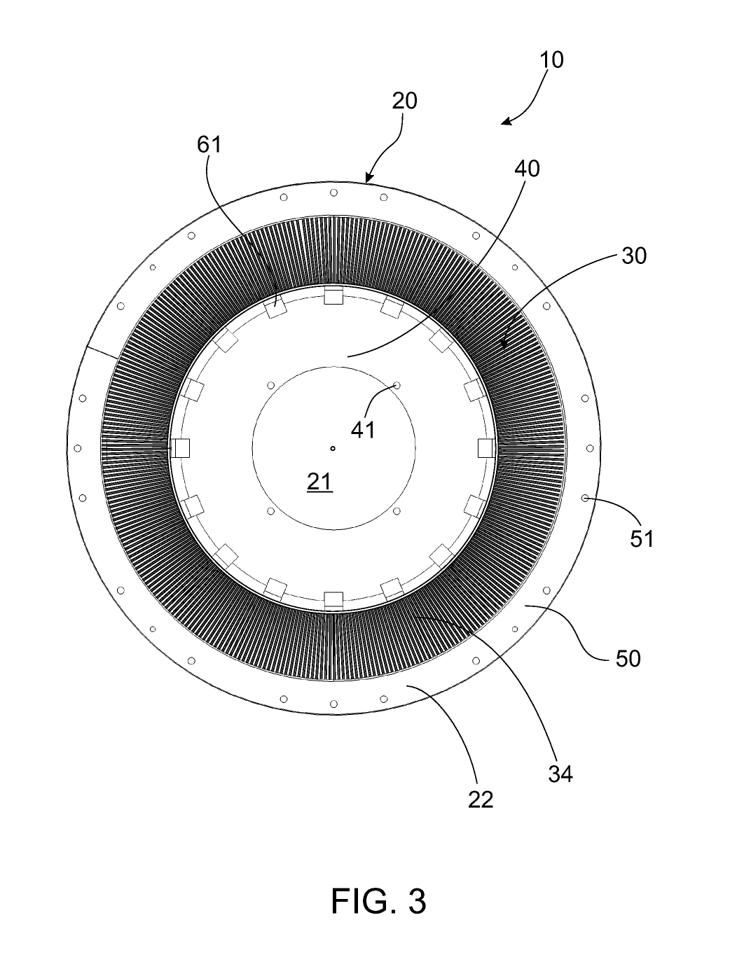

FIG. 3 shows an improved basket 100 that is used within a horizontal centrifuge. Again the basket 100 shown can be used in the HFC 1300 centrifuge is current manufactured by FLsmidth Ludowici Pty Ltd. However it should be appreciated that the basket 100 may be routinely modified to fit within other horizontal centrifuges.

The improved basket 100 is similar to the prior art basket 60. Accordingly, like numerals have been used to describe like components.

The improved basket 100 includes accelerator bars 60 that are of the same length and height as the prior art accelerator bars 50 but are of an increased width. The accelerator bars 61 in this embodiment are 50 mm in width. There are the same number of accelerator bars 61 as the prior art basket 10 and the accelerator bars 61 are again equally circumferentially spaced around the screen member 30.

In use, coal or mineral slurry is fed in the basket 100 adjacent the feed end 21 of the body whilst the basket 100 is spinning. The mineral slurry contacts the basket 100 and accordingly the accelerator bars 61. The accelerator bars 61 contact the coal or mineral slurry and transmit the rotation force of the accelerator bars 61 to the coal or mineral slurry. Although not to be bound by any theory it is believed that the accelerator bar is able to maintain a surface for the material to be accelerated against for a period of time that brings the rate of wear on the screen surface and the accelerator bar into equilibrium. In this specification, the terms “comprise”, “comprises”, “comprising” or similar terms are intended to mean a non-exclusive inclusion, such that a system, method or apparatus that comprises a list of elements does not include those elements solely, but may well include other elements not listed.

It should be appreciated that various other changes and modifications may be made to the embodiment described without departing from the spirit or scope of the invention.

1. A basket for a horizontal centrifuge, the basket comprising:
a frusto-conical body having a series of accelerator bars;
wherein each accelerator bar has a width greater than 20 mm.

2. The basket of claims 1 wherein the body includes a feed end and a delivery end.

3. The basket of claim 2 wherein the feed end is located adjacent a small diameter end of the body whilst the delivery end is located adjacent a large diameter end of the body and a large diameter segment.

4. The basket of claim 1 wherein the fusto-conical body includes a screen member.

5. The basket of claim 4 wherein the screen member includes a series of screen elements.

6. The basket of claim 5 wherein the screen elements are in the form spaced apart wire members.

7. The basket of claim 4 wherein the screen member includes a frame.

8. The basket of claim 7 wherein the frame is formed from a series of axial stringer and circumferential ribs.

9. The basket of claim 4 wherein the series of accelerator bars are located over the screen member.

10. The basket of claim 2 wherein the series of accelerator bars are located adjacent the feed end of the basket.

11. The basket of claim 1 wherein the body includes a feed end flange.

12. The basket of claim 1 wherein the body includes a delivery end flange.

13. The basket of claim 1 wherein the accelerator bars are in the form of a rectangular shaped prism.

14. The basket of claim 1 wherein the height of the accelerator bars are between 10 mm and 30 mm.

15. The basket of claim 1 wherein the height of the accelerator bars are between 15 and 25 mm.

16. The basket of claim 1 wherein the accelerator bars are approximately 20 mm height.

17. The basket of claim 1 wherein the accelerator bars have a width greater than 30 mm.

18. The basket of claim 1 wherein the accelerator bars are have a width greater than 40 mm.

19. The basket of claim 1 wherein the accelerator bars the accelerator bars have a width between 20 mm and 70 mm.

20. The basket of claim 1 wherein the accelerator bars have a width between 35 mm and 55 mm.
